(19) United States
(12) Patent Application Publication
(10) Pub. No.: US 2005/0264964 A1
(43) Pub. Date: Dec. 1, 2005

(54) Semiconductor circuit

(76) Inventors: Aristotle Malay Coronel, Atsugi-shi (JP); Nobuo Saito, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/135,327

(22) Filed: May 24, 2005

(30) Foreign Application Priority Data
May 26, 2004 (JP) 2004-156395
Apr. 18, 2005 (JP) 2005-119926

(51) Int. Cl. H02H 9/00

(52) U.S. Cl. 361/56

(57) ABSTRACT

This invention includes a circuit (11) to be protected and an ESD protection circuit (2) which protects the circuit (11) to be protected against electrostatic discharge. The circuit (11) to be protected includes a bipolar transistor (TR1), and the emitter of the bipolar transistor (TR1) is connected to an external connection terminal (3). A current limiting element (Z) is provided between the collector of the bipolar transistor (TR1) and a first power supply terminal (4). When a negative ESD pulse is applied to the external connection terminal (3) with respect to a power supply voltage of the first power supply terminal (4), the current limiting element (Z) limits the emitter current of the bipolar transistor (TR1) and protects the transistor (TR1) against any breakdown.

### BACKGROUND OF THE INVENTION

1. Field of the Invention

The present invention relates to a semiconductor circuit comprising ESD devices for protection against electrostatic discharge, and more particularly to a methodology of increasing the ESD withstand voltage of the circuit to be protected when such circuit is composed of bipolar transistors.

2. Description of the Related Art

For example, integrated semiconductor circuits may be subjected to electrostatic discharge (ESD) due to contact with a human body or any conductive matter and consequently may result to electrostatic breakdown. For this reason, most semiconductor circuits are reinforced with ESD protection devices to shield and protect them from damages caused by ESD.

FIG. 5 shows an example of a conventional semiconductor circuit of this type. As shown in FIG. 5, the semiconductor circuit comprises a circuit 1 to be protected (CTP 1), an ESD protection circuit 2 which protects the CTP 1 against ESD, an input/output connection (I/O) terminal 3 which is the external interface of the CTP 1, a first power supply terminal 4 and a second power supply terminal 5 which are the supply voltage terminals of the CTP 1.

The ESD protection circuit 2 comprises PN-junction diodes 21 and 22 serving as input/output ESD protection devices, and a power clamp 23 for inter-power supply ESD protection.

The diode 21 is connected between the I/O terminal 3 and the first power supply terminal 4. The diode 22 is connected between the I/O terminal 3 and the second power supply terminal 5.

The power clamp 23 is connected between the first power supply terminal 4 and the second power supply terminal 5. The power clamp 23 is a gate-coupled NMOS configuration, consisting of a MOS transistor M1, a capacitor C1, and a resistor R10. The capacitor C1 serves as external trigger to the MOS transistor M1 during snapback operation.

Next, the operation in which the ESD protection circuit 2 protects the CTP 1 against ESD in the semiconductor circuit will be explained.

In the ESD protection circuit 2, when an ESD pulse is applied to the I/O terminal 3, the electric charges are generally discharged through one ormoreof the diode 21, diode 22, and the power clamp 23 along any one of the current paths A, B, C, and D shown in FIG. 5, depending on the ESD pulse application conditions.

Current path A is the path through which current flows when a positive ESD pulse is applied to the I/O terminal 3 with respect to the first power supply terminal 4. The current flows to the I/O terminal 3 through the diode 21.

Current path B is the path through which current flows when a negative ESD pulse is applied to the I/O terminal 3 with respect to the secondpower supply terminal 5. The current flows to the I/O terminal 3 through the diode 22.

Current path C is the path through which current flows when a positive ESD pulse is applied to the I/O terminal 3 with respect to the second power supply terminal 5. The current flows to the second power supply terminal 5 through the diode 21, the power supply line connected to the first power supply terminal 4, and the power clamp 23.

Current path D is the path through which current flows when a negative ESD pulse is applied to the I/O terminal 3 with respect to the first power supply terminal 4. The current flows to the I/O terminal 3 through the power clamp 23, the power supply line connected to the second power supply terminal 5, and the diode 22.

However, if the CTP 1 is a bipolar transistor circuit, the current flow during the discharge is not always the case as described by current paths A, B, C and D. In other words, a portion of the current flows into the CTP 1 before escaping to the I/O terminal 3, and it is therefore necessary to consider the probable internal paths to the CTP 1, which may be prone to ESD damage.

One possible way of limiting the current flow to the CTP 1 and diverting the current flow mainly to the ESD protection devices is by inserting a transistor between the I/O terminal 3 and the CTP 1.

This method however, is not suitable for high-frequency application ICs. More specifically, if the I/O terminal 3 is an input terminal connected to the base terminal of a bipolar transistor, a resistor needs to be connected between the input terminal and the base terminal of the bipolar transistor of the CTP 1. In this case, the resistor adds to the base resistance of the bipolar transistor, thereby degrading the high-frequency characteristics of the CTP 1.

Meanwhile, if the I/O terminal 3 is an output terminal, the bipolar transistor itself of the CTP 1 limits the output current. Accordingly, it is difficult to series-connect a resistor between the output terminal and the bipolar transistor, inadvertently increasing the output load of the circuit.

Next is a more specific explanation of the problem that may occur in semiconductor circuit when the CTP 1 is composed of bipolar transistors as shown in FIG. 6.

In FIG. 6, the CTP 1 is composed of bipolar transistors TR1 and TR2, resistors R1 and R2, and the like.

The resistor R1 is connected between the first power supply terminal 4 and the base terminal of the bipolar transistor TR1, and is the bias source of the bipolar transistor TR1. The current source resistor R2 is connected between the emitter terminal of the bipolar transistor TR2 and the second power supply terminal 5.

Next, the current paths A to D taken when an ESD pulse is applied to the I/O terminal 3 in the semiconductor circuit with this configuration will be considered.

Comparing the DC voltage level for each of the current paths A to D at which current starts to flow when an ESD pulse is applied to the I/O terminal 3, the voltage level for the current path D, i.e., one at which current starts to flow when a negative ESD pulse is applied to the I/O terminal 3 with respect to the first power supply terminal 4, is apparently the lowest.

The current path A is the path taken when a positive ESD pulse is applied to the I/O terminal 3 with respect to the first power supply terminal 4. The possible current paths in this case are a path through the emitter and collector of the bipolar transistor TR1 and a forward path of the diode 21, as can be seen from FIG. 6.

Here, the forward ON voltage of the diode 21 is lower than the breakdown voltage across the emitter and collector of the bipolar transistor TR, thus current escapes through the diode 21 toward the first power supply terminal 4.

The current path B is the path taken when a negative ESD pulse is applied to the I/O terminal 3 with respect to the second power supply terminal 5. The possible current paths in this case are a path through the emitter and collector of the bipolar transistor TR2 and a forward path of the diode 22, as can be seen from FIG. 6.

Here, the forward ON voltage of the diode 22 is lower than the breakdown voltage across the emitter and collector of the bipolar transistor TR2, thus current escapes through the diode 22 toward the I/O terminal 3.

The current path C is the path taken when a positive ESD pulse is applied to the I/O terminal 3 with respect to the second power supply terminal 5. The possible current paths in this case are a forward path of the diode 21 and a path through the power clamp 23, as can be seen from FIG. 6. Alternatively, the possible current paths are a path through the emitter and collector of the bipolar transistor TR1 and the path through the power clamp 23.

Here, the forward ON voltage of the diode 21 is lower than the breakdown voltage across the emitter and collector terminals of the bipolar transistor TR1, thus current escapes through the diode 21 and the power clamp 23 toward the second power supply terminal 5.

Note that at this time, since the resistor R2 is connected between the emitter terminal of the bipolar transistor TR2 and the second power supply terminal 5, the voltage drop at the resistor R2 reduces the current flowing through the emitter and collector of the bipolar transistor TR2.

The current path D is the path taken when a negative ESD pulse is applied to the I/O terminal 3 with respect to the first power supply terminal 4. The possible current paths in this case are apath through the base and emitter of the bipolar transistor TR1, a forward path of the power clamp 23, and a forward path of the diode 22, as can be seen from FIG. 6.

Here, the ON voltage across the base and emitter of the bipolar transistor TR1 is lower than those of diode 22 and power clamp 23, current escapes from the first power supply terminal 4 through the bipolar transistor TR1 of the CTP 1 toward the I/O terminal 3. For this reason, when a negative ESD pulse is applied to the I/O terminal 3, the base-emitter junction of the bipolar transistor TR1 is forward biased. Consequently, bipolar transistor TR1 is turned on, and the bipolar action results to an excessive current flow through the collector toward the emitter, which eventually raises the temperature of bipolar transistor TR1, thus resulting to thermal breakdown.

From the above consideration, if the CTP 1 is composed of bipolar transistors, the damage apparently occurs in the CTP 1 only when a negative ESD pulse is applied to the I/O terminal 3 with respect to the first power supply terminal 4.

As mentioned earlier, when a negative ESD pulse is applied toward the I/O terminal 3 with respect to the first power supply terminal 4, the electric charges are discharged through the power clamp 23, the power supply line for the second power supply terminal 5, and the diode 22 along the current path D, as shown in FIG. 5. The ESD protection circuit 2 is expected to protect the CTP 1 for this kind of operation.

However, for bipolar transistor circuit configurations, before the power clamp 23 and the diode 22 reach the combined turn ON voltages, a large portion of current is already flowing though the bipolar transistor TR1. Accordingly, the ESD protection circuit cannot prevent the thermal damage in bipolar transistor TR1.

The problem will then be explained using specific numerical values.

In the case of the diode 21, the breakdown voltage upon application of a reverse bias is approximately 10 V. In the case of diode 22, the forward ON voltage is approximately 0.7 V. The snapback voltage of the power clamp 23, which is its turn ON voltage under ESD condition, is approximately 6 V.

For the current to flow in the direction of current path D, the voltage at the I/O terminal 3 has to reach 6.7 V, where both the power clamp 23 and the diode 22 are turned on.

However, at about 0.7 V base-emitter bias voltage, the bipolar transistor TR1 is turned on, allowing a large current flow trough the collector toward the emitter. This bipolar action results to the thermal breakdown of bipolar transistor TR1.

A bipolar transistor differential amplifier configuration, which includes a resistor to protect the bipolar transistor against any ESD breakdown, as shown in FIG. 7 is known from, e.g. Japanese Patent Laid-OpenNo. 59-210704 issued by Japan Patent Office.

In the circuit shown in FIG. 7, the emitter terminals of bipolar transistors TR11 and TR12 which constitute the input stage of the differential amplifier circuit are connected together, and a resistor R11 for preventing any ESD breakdown is provided between the common emitter terminals of TR11 and TR12, and the collector of a bipolar transistor TR13 which constitutes a constant current source.

Input terminals 7 and 8, which constitute a differential input connection of the circuit shown in FIG. 7 are connected through resistors R12 and R13 to the base terminals of the bipolar transistors TR11 and TR12, respectively.

As described above, the circuit shown in FIG. 7 incorporates the resistor R11. This configuration limits the current caused by ESD applied to either input terminals 7 and 8 and prevents any breakdown of either bipolar transistor TR11 and TR12.

However, in the circuit shown in FIG. 7, the emitters of the bipolar transistors TR11 and TR12 to be protected are not connected to the circuit external interface. Accordingly, no consideration is given for protection against an ESD pulse applied to the emitter of the bipolar transistor when the emitter of the bipolar transistor is connected to an external interface like the semiconductor circuit described in FIG. 6.

A circuit arrangement in which a bipolar transistor and current limiting element are incorporated as electrostatic breakdown preventing elements, as shown in FIG. 8, is known from, e.g., Japanese Patent Laid-Open No. 55-128857 issued by Japan Patent Office.

In the circuit shown in FIG. 8, a resistor R81 is connected between a collector terminal 81 of a bipolar transistor Q and a power supply voltage terminal V_{cc}. A resistor R82 connected to a base terminal 82 and an emitter terminal 83 of the bipolar transistor Q represents a small resistance component between the emitter and base of the bipolar transistor Q.

In this circuit, the current that flows into the collector terminal 81 of the bipolar transistor Q serving as a protection element is limited by the resistor R81, and thus the bipolar transistor Q can be prevented from any ESD breakdown.

As described above, the circuit shown in FIG. 8 offers only a methodology for protecting the ESD protection element Q itself against ESD damage, and does not introduce a method for protecting circuit section 84 to be protected.

More specifically, in the above methodology, the ESD protection is a diode-connected bipolar transistor, and comprises the resistor R81 limiting current between the collector and the power supply thereby protecting the ESD protection itself. The prevention of current flow to the ESD protection facilitates the current flow to the circuit section 84 to be protected, and the circuit section 84 to be protected can be damaged before the ESD protection operates. Thus, it is difficult to obtain a high ESD withstand voltage.

### SUMMARY OF THE INVENTION

The present invention to provides a methodology for increasing the ESD withstand of a semiconductor circuit that may include bipolar transistor circuits, without degrading its high-frequency characteristics.

The present invention comprises an external interface, first power supply terminal, second power supply terminal, abipolar transistor at an output stage whose emitter terminal is connected to the external interface and which is connected in an emitter-follower configuration, a first ESD protection means connected between the first power supply terminal and the external connection terminal, a second ESD protection means connected between the second power supply terminal and the external interface, an inter-power supply ESD protection means (power clamp) connected between the first power supply terminal and the second power supply terminal, and a current limiting means connected between a collector terminal of the bipolar transistor and the first power supply terminal, and the current limiting means protects the bipolar transistor from ESD when an ESD pulse is applied to the external connection terminal.

The current limiting means protects the bipolar transistor against ESD such that a current generated by the ESD pulse flows to the second ESD protection means and the power clamp.

The current limiting means limits an emitter current of the bipolar transistor and protects the bipolar transistor against ESD.

The current limiting means protects the bipolar transistor against ESD when a negative ESD pulse is applied to the external connection terminal with respect to a power supply voltage of the first power supply terminal.

The current limiting means further protects, against ESD, a PN-junction between a base and emitter of the bipolar transistor.

The current limiting means is composed of a resistance element.

An impedance Z [Ω] of the current limiting means satisfies the following relation:
(Vₒₙ/IEₘₐₓ)<Z<[{(VDD−VE)−VCEₘᵢₙ}/IC]
where Vₒₙ, [V] represents an ON voltage of the power clamp, IEₘₐₓ [A] represents a maximum value of an emitter current that can be handled by the bipolar transistor, VCEₘᵢₙ [V] represents the minimum collector-to-emitter voltage to operate the bipolar transistor, VE [V] represents an emitter voltage when the bipolar transistor is in operation, IC [A] represents a collector current when the bipolar transistor is in operation, and VDD [V] represents the voltage of the first power supply terminal.

The first ESD protection means comprises a diode connected, in a forward direction, between the first power supply terminal and the external interface, the second ESD protection means comprises a diode connected, in a forward direction, between the external interface and the second power supply terminal, and the power clamp is a gate-coupled NMOS configuration, consisting of a MOS transistor, a capacitor, and a resistor. The capacitor serves as external trigger to the NMOS transistor during snapback operation.

The first power supply terminal is a positive power supply terminal, and the second power supply terminal is a negative power supply terminal. The bipolar transistor is the circuit to be protected (CTP).

A plurality of bipolar transistors and current limiting means may be connected in parallel with respect to the external connection terminal, in addition to the bipolar transistor and current limiting means.

The present invention may further comprise another bipolar transistor connected between the former bipolar transistor and the external interface, in which a base terminal is connected to the emitter terminal of the former bipolar transistor and a collector terminal is connected to the external interface.

As described above, the present invention is a semiconductor device, which comprises a bipolar transistor at an output stage and ESD protection means for protecting the bipolar transistor against ESD and, more particularly, comprises a current limiting element (current limiting means) between the collector of the bipolar transistor and a power supply.

According to the present invention, the current generated by an ESD pulse flows only to the ESD protection means, and by employing a current limiting element, the current flowing to the bipolar transistor at the output stage is reduced to a very minimal level. For this reason, the present invention is effective in increasing the ESD withstand voltage at the output stage of a bipolar transistor circuit.

### BRIEF DESCRIPTION OF THE DRAWINGS

FIG. 1 is a circuit diagram showing the arrangement of the first embodiment of a semiconductor circuit according to the present invention;

FIG. 2 is a diagram showing an example of a current limiting element;

FIG. 3 is a circuit diagram showing the arrangement of the second embodiment of a semiconductor circuit according to the present invention;

FIG. 4 is a circuit diagram of the second embodiment that specifies the configuration of a bipolar transistor circuit;

FIG. 5 is a circuit diagram showing the arrangement of a conventional circuit;

FIG. 6 is a circuit diagram of the conventional circuit that specifies a circuit to be protected;

FIG. 7 is a circuit diagram showing another arrangement example of the conventional circuit; and

FIG. 8 is a circuit diagram showing an arrangement example of an ESD protection element that uses a conventional bipolar transistor.

### DETAILED DESCRIPTION OF THE PREFERRED EMBODIMENTS

Embodiments of a semiconductor circuit according to the present invention will be explained below with reference to the drawings.

### First Embodiment

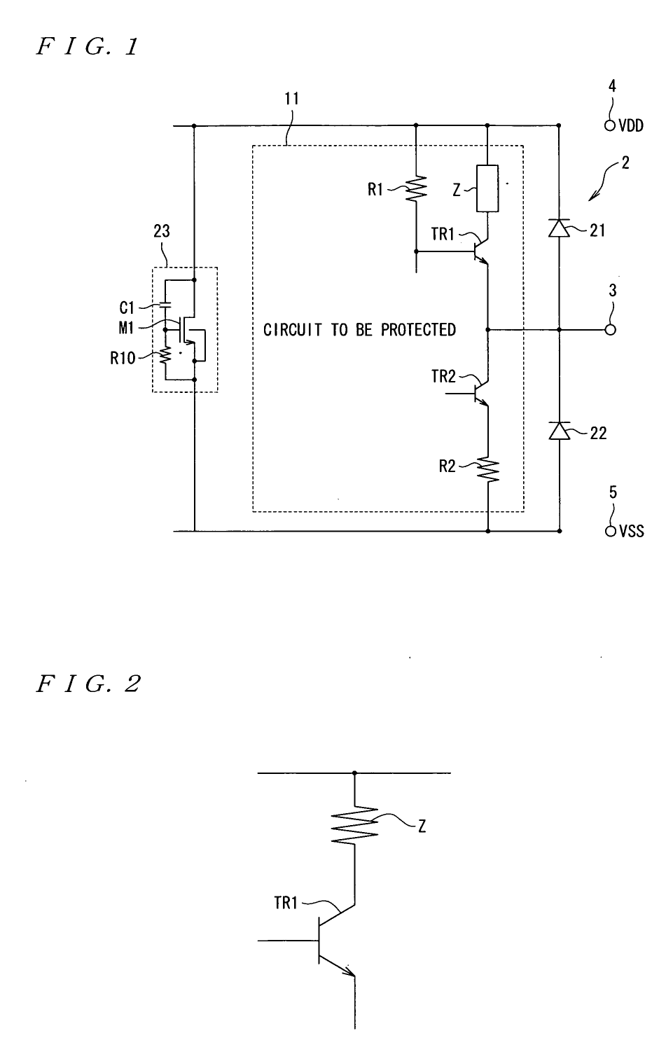

FIG. 1 is a circuit diagram showing the arrangement of the first embodiment of a semiconductor circuit according to the present invention.

As shown in FIG. 1, the first embodiment comprises a circuit 11 to be protected (CTP 11), an ESD protection circuit 2 which protects the CTP 11 against ESD, an I/O terminal 3 which is the external interface of the CTP 11, and a first power supply terminal 4 and a second power supply terminal 5 which are the supply voltage terminals of the CTP 11.

The CTP 11 is a circuit that receives a predetermined signal from the outside, performs predetermined processing for the signal, and outputs it. The CTP 11 is connected to the I/O terminal 3 serving as an input/output terminal. As shown in FIG. 1, the CTP 11 comprises, e.g., NPN-type bipolar transistors TR1 and TR2 and resistors R1 and R2 and includes a current limiting element Z for protecting the bipolar transistor TR1 against ESD breakdown.

More specifically, CTP 11 includes a bipolar transistor TR1 at the output stage whose emitter is connected to the I/O terminal 3 and which is connected in an emitter-follower configuration. Additionally, the current limiting element Z serving as current limiting means, is connected between the collector of the bipolar transistor TR1 and the first power supply terminal 4.

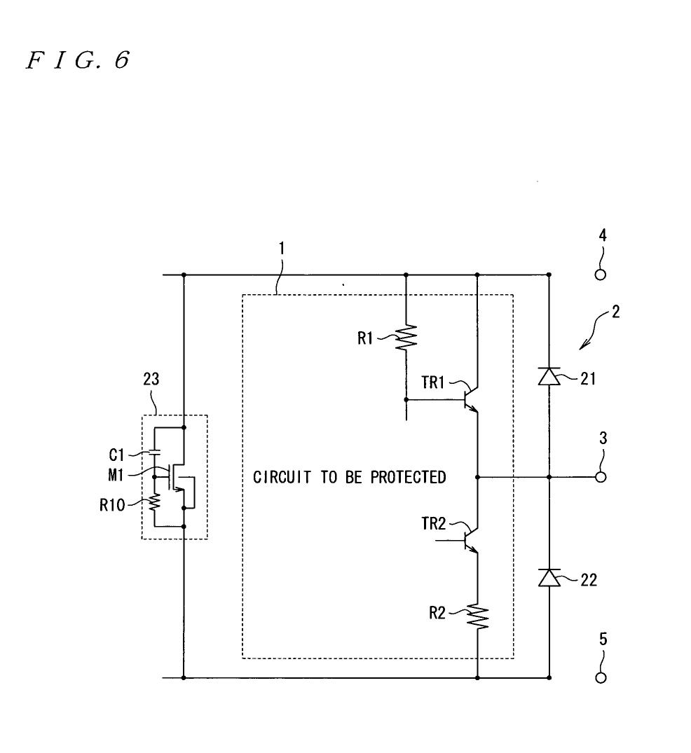

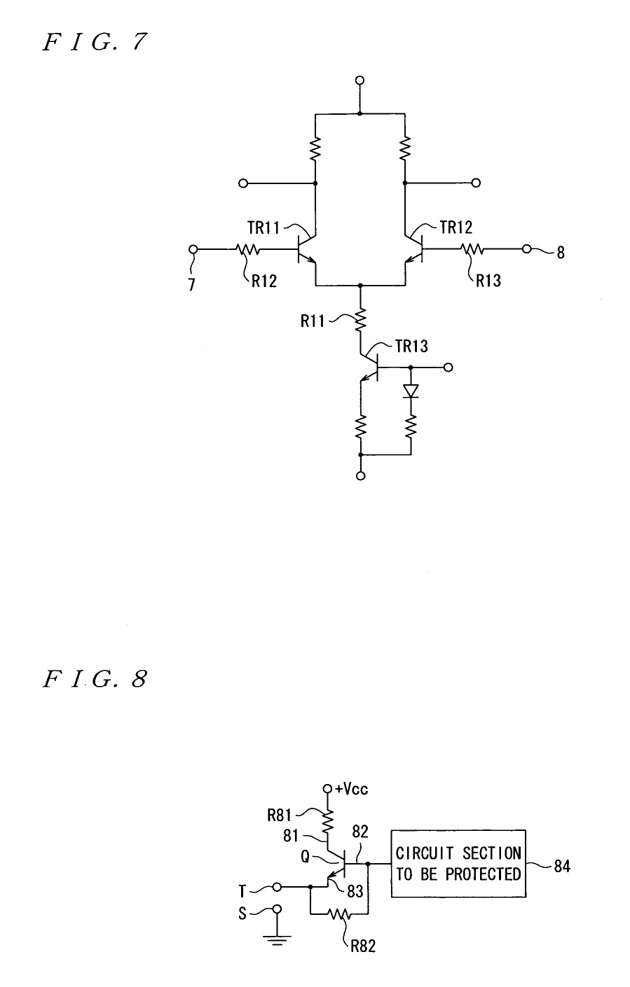

As described above, the CTP 11 is different from the CTP 1 shown in FIG. 6 in that the CTP 11 includes a current limiting element Z.

The following is a detailed description of the CTP 11. The base of the bipolar transistor TR1 is connected to the first power supply terminal 4 through the resistor R1. The emitter of the bipolar transistor TR1 is connected to the I/O terminal 3 and the collector of the bipolar transistor TR2. The collector of the bipolar transistor TR1 is connected to the first power supply terminal 4 through the current limiting element Z. The emitter of the bipolar transistor TR2 is connected to the second power supply terminal 5 through the resistorR2. ThebaseofthebipolartransistorTR2 is connected to a predetermined part (not shown).

A high-potential (positive-potential) power supply voltage VDD is supplied to the first power supply terminal 4 while a low-potential (negative-potential) power supply voltage VSS is supplied to the second power supply terminal

As shown in FIG. 2, the current limiting element Z is composed of, e.g., a resistance element. One end of the resistance element is connected to the first power supply terminal 4 while the other end is connected to the collector of the bipolar transistor TR1.

As shown in FIG. 1, the ESD protection circuit 2 is composed of PN-junction diodes 21 and 22 serving as input/output ESD protection elements and a power clamp 23.

The diode 21 constitutes first ESD protection means; the diode 22, the second ESD protection means; and the power clamp 23, inter-power supply ESD protection means.

The diode 21 is connected between the I/O terminal 3 and the first power supply terminal 4. More specifically, the anode of the diode 21 is connected to the I/O terminal 3 while the cathode is connected to the first power supply terminal 4.

The diode 22 is connected between the I/O terminal 3 and the second power supply terminal 5. More specifically, the anode of the diode 22 is connected to the second power supply terminal 5 while the cathode is connected to the I/O terminal 3.

As shown in FIG. 1, the power clamp 23 is a gate-coupled NMOS configuration, consisting of a MOS transistor M1, a capacitor C1, and a resistor R10. The capacitor C1 serves as external trigger to the MOS transistor M1 during snapback operation. The power clamp 23 is provided between the first power supply terminal 4 and the second power supply terminal 5.

More specifically, the drain of the MOS transistor M1 is connected to the first power supply terminal 4 while the source is connected to the second power supply terminal 5. The resistor R10 is connected between the gate and source of the MOS transistor M1, and the capacitor C1 is connected between the gate and drain of the MOS transistor M1.

Next, an example of operation of the first embodiment with this arrangement will be explained with reference to FIGS. 1 and 2.

A case will be explained wherein a negative ESD pulse is applied to the I/O terminal 3 with respect to the first power supply terminal 4. In this case, even if a voltage applied across the base and emitter of the bipolar transistor TR1 of the CTP 11 exceeds a voltage level VTR1 which is sufficient to turn on the bipolar transistor TR1, the amount of current that flows into the collector of the bipolar transistor TR1 is limited, by the impedance Z of the current limiting element Z, to VTR1/Z. The voltage level VTR1 rises with time.

When the potential level VTR1 exceeds the clamp voltages of the diode 22 and power clamp 23, current flows from the first power supply terminal 4 through the power clamp 23 and the diode 22 toward the I/O terminal 3, thereby protecting the bipolar transistor TR1 against ESD.

Assume that the current limiting element Z is a resistance element as shown in FIG. 2 and that the resistance of the resistance element is 50 [Ω]. When an ESD pulse is applied to the I/O terminal 3, and a transient current generated by the ESD pulse reaches about 134 [mA], the voltage applied to the first power supply terminal 4 of FIG. 1 rises to about 6.7 [V].

At this time, the power clamp 23 and the diode 22 are turned on, and current flows through the power clamp 23 and diode 22 toward the I/O terminal 3. When the power clamp 23 and the diode 22 are turned on, major portion of the current flows through the power clamp 23 and diode 22 until the ESD pulse decays, thereby protecting the circuit 11 to be protected against any breakdown.

A minimum value Zₘᵢₙ of the impedance of the current limiting element Z depends on a maximum current Imax which the bipolar transistor TR1 can handle until the voltage of the power clamp 23 reaches an ON voltage Vₒₙ, defined by the relation:
Zₘᵢₙ>(Vₒₙ/Iₘₐₓ)

Assume that the impedance of the current limiting element Z is made lower than Zₘᵢₙ. In this case, when an ESD pulse is applied, a transient current that flows to the bipolar transistor TR1 exceeds Iₘₐₓ, and the bipolar transistor TR1 breaks down.

For example, if the ESD withstand voltage of the bipolar transistor TR1 is 300 [V], the transient current Imax that the bipolar transistor TR1 can handle becomes 200 [mA].

Accordingly, if the ON voltage Vₒₙ of the power clamp 23 is 6 [V], the bipolar transistor TR1 cannot be protected unless Zₘᵢₙ is equal to or greater than 30 [Ω], as can be seen from the above relation.

On the other hand, a maximum value Zₘₐₓ of the impedance of the current limiting element Z depends on a minimum voltage VCEₘᵢₙ across the collector and emitter for operation of the bipolar transistor TR1, defined by the relation:
Zₘₐₓ<{(VDD−VE)−VCEₘᵢₙ}/IC
where VE represents the emitter voltage of the bipolar transistor TR1; and IC, the collector current of the bipolar transistor TR1 during operation.

If the impedance of the current limiting element Z is made higher than Zₘₐₓ, the voltage applied to the current limiting element Z drops too low. As a result, the operating range for the bipolar transistor TR1 narrows, and the bipolar transistor TR1 ceases operation.

For example, assume that VDD is 3.0 [V], VE is 1.5 [V], VCEₘᵢₙ is 300 [mV], and the current IC to be fed is 1 [mA]. In this case, the bipolar transistor circuit does not operate unless Zₘₐₓ is equal to or less than 1.2 [kΩ], as can be seen from the above relation.

Thus, the impedance Z of the current limiting element Z needs to satisfy the following relation:
(Vₒₙ/Iₘₐₓ)<Z<{(VDD−VE)−VCEₘᵢₙ}/IC

In the above-described first embodiment, a plurality of bipolar transistors and a current limiting element may be connected as one unit in parallel with respect to the external interface, in addition to the bipolar transistor TR1 and current limiting element Z. This arrangement is preferable in that the one unit acts as a ballast resistor.

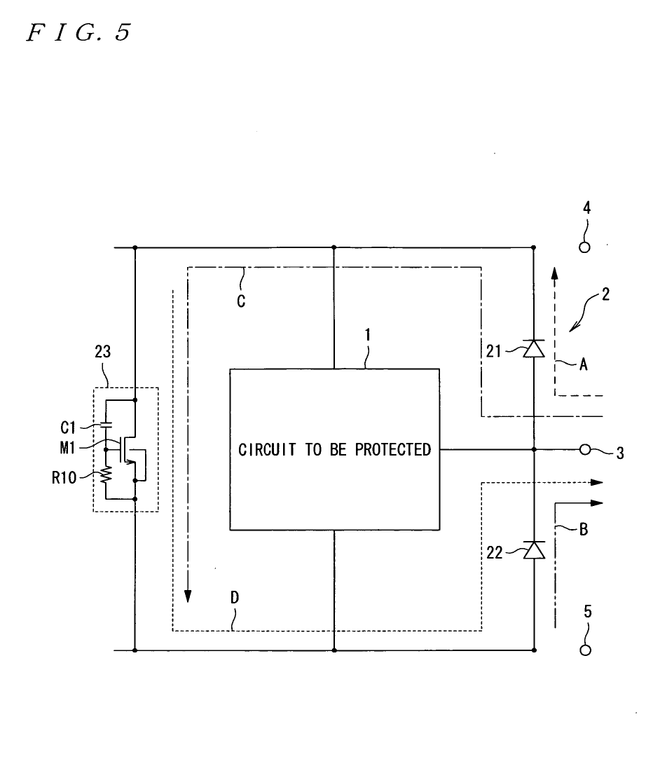

The operation of a case wherein a negative ESD pulse is applied to the I/O terminal 3 with respect to the first power supply terminal 4 has been explained. However, the first embodiment includes operations corresponding to the current paths A, B, and C described as for the conventional circuit of FIG. 5, in addition to the operation. Since these operations are same as those of the conventional circuit of FIG. 5, an explanation thereof will be omitted.

As has been explained above, according to the first embodiment, if the CTP 11 includes a bipolar transistor, and the emitter of the transistor is connected to the I/O terminal 3, the ESD withstand voltage of the CTP 11 can be increased.

### Second Embodiment

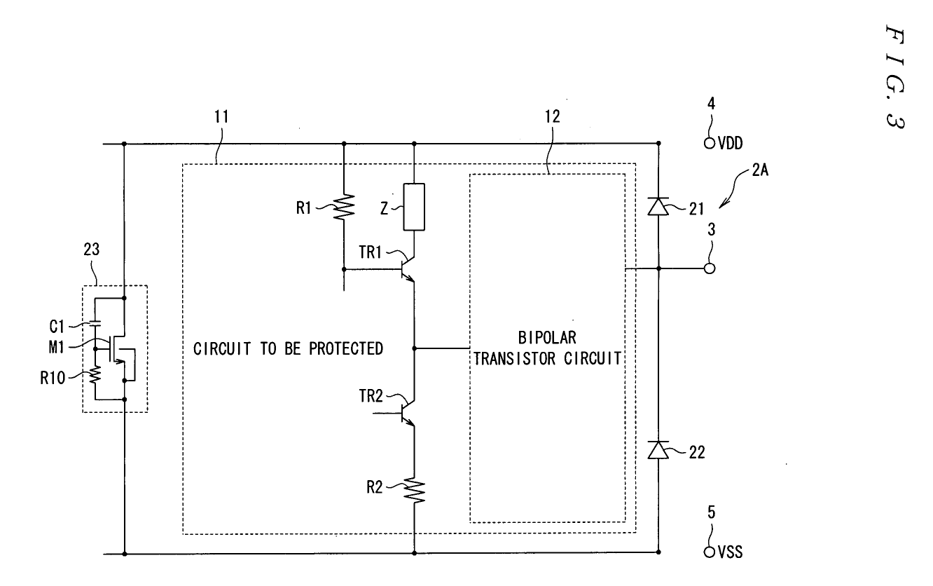

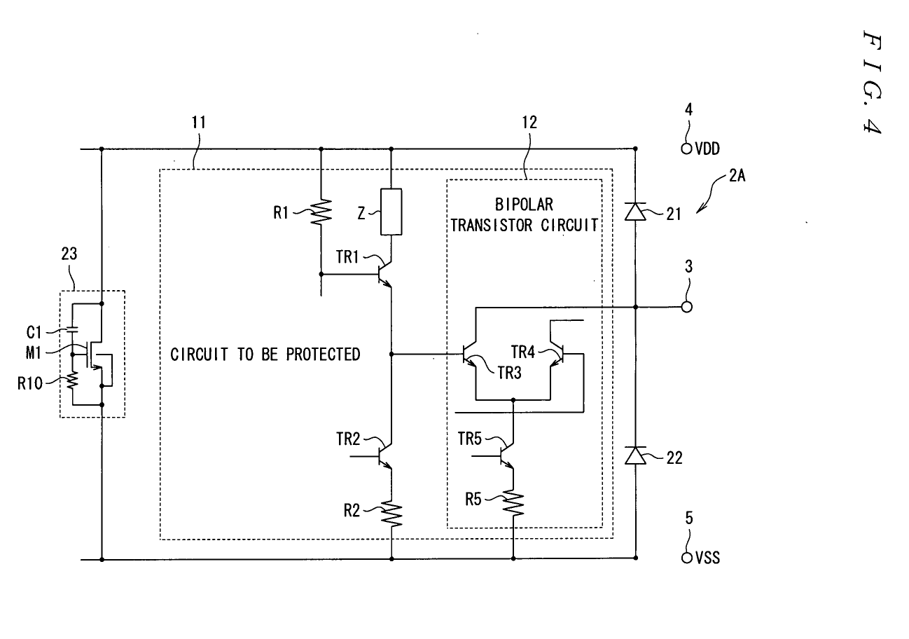

FIGS. 3 and 4 are circuit diagrams showing the arrangement of the second embodiment of a semiconductor circuit according to the present invention.

As shown in FIG. 3, the second embodiment comprises a circuit 11 to be protected (CTP 11), an ESD protection circuit 2A which protects the CTP 11 against electrostatic discharge, an I/O terminal 3, a first power supply terminal 4, and a second power supply terminal 5. The CTP 11 comprises NPN-type bipolar transistors TR1 and TR2, resistors R1 and R2, and a current limiting element Z for protecting the bipolar transistor TR1 against any ESD breakdown and further comprises a bipolar transistor circuit 12.

More specifically, the second embodiment is based on the first embodiment shown in FIG. 1, and interposes the bipolar transistor circuit 12 including a bipolar transistor between an output stage having the bipolar transistor TR1 and the I/O terminal 3, as shown in FIG. 3. Accordingly, in the second embodiment, the emitter of the bipolar transistor TR1 at the output stage is connected to the I/O terminal 3 through the bipolar transistor circuit 12.

Since the specific arrangement of the circuit 11 to be protected and ESD protection circuit 2A according to the second embodiment is the same, except for the bipolar transistor circuit 12, as that of the circuit 11 to be protected and ESD protection circuit 2 according to the first embodiment shown in FIG. 1. The same constituent elements as those in the first embodiment are denoted by the same reference numerals, and an explanation thereof will be omitted.

As shown in FIG. 4, the bipolar transistor circuit 12 comprises NPN-type bipolar transistors TR3 and TR4 which constitute a differential pair, an NPN-type bipolar transistor TR5 for supplying a constant current to the differential pair, and a resistor R5. The resistor R5 is connected between the emitter terminal of the bipolar transistor TR5 serving as a current source and the second power supply terminal 5.

More specifically, the emitters of the bipolar transistors TR3 and TR4 are connected together, and the common terminal is connected to the second power supply terminal 5 through the bipolar transistor TR5 and resistor R5. The base of the bipolar transistor TR3 is connected to the emitter of the bipolar transistor TR1 at the output stage. The collector of the bipolar transistor TR3 is connected to the I/O terminal 3. The base and collector of the bipolar transistor TR4 are respectively connected to predetermined parts (not shown)

Next, an example of operation of the second embodiment with this arrangement will be explained with reference to FIG. 4.

In the second embodiment, similarly to the first embodiment shown in FIG. 1, when a negative ESD pulse is applied to the I/O terminal 3 with respect to the first power supply terminal 4, current passes through the bipolar transistor TR1 and flows to the I/O terminal 3 through the base and collector of the bipolar transistor TR3 of the bipolar transistor circuit 12.

The current limiting element Z of FIG. 4 limits the amount of current that flows into the bipolar transistor TR1 of the CTP 11. A large current flows through the power clamp 23 and diode 22 toward the I/O terminal 3, thereby protecting the CTP 11 against any ESD breakdown.

Note that the bipolar transistor circuit 12 which connects to the I/O terminal 3 is not limited to the arrangement shown in FIG. 4 and that the bipolar transistor circuit 12 preferably constitutes a path which allows current to easily flow to the I/O terminal 3.

As has been described above, according to the second embodiment, if the bipolar transistor circuit 12 is interposed between an output stage having the bipolar transistor TR1 and the I/O terminal 3, the ESD withstand voltage of the CTP 11 can be increased.

### Other Embodiment

A semiconductor device according to each of the above-described embodiments is useful as a semiconductor device for a high-frequency communication system that utilizes a bipolar transistor circuit.

Therefore, a high-frequency IC according to the present invention comprises a semiconductor device according to each of the above-described embodiments.

1. A semiconductor circuit comprising:
an external connection terminal, first power supply terminal, and second power supply terminal;
a bipolar transistor at an output stage whose emitter terminal is connected to the said external connection terminal and which is connected in an emitter-follower configuration;
first ESD protection means connected between the said first power supply terminal and the said external connection terminal;
second ESD protection means connected between the said second power supply terminal and the said external connection terminal;
inter-power supply ESD protection means connected between the said first power supply terminal and the said second power supply terminal; and
current limiting means connected between a collector terminal of the said bipolar transistor and said first power supply terminal,
wherein the said current limiting means protects the said bipolar transistor from ESD when an ESD pulse is applied to the said external connection terminal.

2. The semiconductor circuit according to claim 1, wherein the said current limiting means protects the said bipolar transistor against ESD such that a current generated by the ESD pulse flows to the said second ESD protection means and inter-power supply ESD protection means.

3. The semiconductor circuit according to claim 1, wherein the said current limiting means limits an emitter current of the said bipolar transistor and protects the said bipolar transistor against ESD.

4. The semiconductor circuit according to claim 1, wherein the said current limiting means protects the said bipolar transistor against ESD when a negative ESD pulse is applied to the said external connection terminal with respect to a power supply voltage of the said first power supply terminal.

5. The semiconductor circuit according to claim 1, wherein the said current limiting means protects, against ESD, a PN-junction between a base and emitter of the said bipolar transistor.

6. A semiconductor circuit comprising:
an external connection terminal, first power supply terminal, and second power supply terminal;
a bipolar transistor at an output stage whose emitter terminal is connected to the said external connection terminal and which is connected in an emitter-follower configuration;
first ESD protection means connected between the said first power supply terminal and the said external connection terminal;
second ESD protection means connected between the said second power supply terminal and the said external connection terminal;
inter-power supply ESD protection means connected between the said first power supply terminal and the said second power supply terminal; and
current limiting means connected between a collector terminal of the said bipolar transistor and the said first power supply terminal.

7. The semiconductor circuit according to claim 6, wherein the said current limiting means is a resistance element.

8. The semiconductor circuit according to claim 6, wherein an impedance Z [Ω] of the said current limiting means satisfies a relation:
(Vₒₙ/IEₘₐₓ)<Z<[{(VDD−VE)−VCEₘᵢₙ}/IC]
where Vₒₙ [V] represents an ON voltage of the said inter-power supply ESD protection means, IEₘₐₓ [A] represents a maximum emitter current value that can be handled by the said bipolar transistor, VCEₘᵢₙ [V] represents a minimum collector-to-emitter voltage when the said bipolar transistor is in operation, VE [V] represents an emitter voltage when the said bipolar transistor is in operation, IC [A] represents the collector current when the said bipolar transistor is in operation, and VDD [V] represents the voltage of said first power supply terminal.

9. The semiconductor circuit according to claim 6, wherein
the said first ESD protection means comprises a diode connected, in a forward direction, between the said first power supply terminal and the said external connection terminal,
the said second ESD protection means comprises a diode connected, in a forward direction, between the said external connection terminal and the said second power supply terminal, and
the said inter-power supply ESD protection means comprises a resistor, capacitor, and MOS transistor and causes the MOS transistor to perform snapback operation to feed current.

10. The semiconductor circuit according to claim 9, wherein the said first power supply terminal is a positive power supply terminal, and the said second power supply terminal is a negative power supply terminal.

11. The semiconductor circuit according to claim 6, wherein the said bipolar transistor is a circuit to be protected.

12. The semiconductor circuit according to claim 6, wherein a plurality of bipolar transistors and current limiting means are connected in parallel with respect to the said external connection terminal, in addition to the said bipolar transistor and current limiting means.

13. A high-frequency IC comprising a semiconductor circuit according to claim 6.

14. A semiconductor circuit comprising:
an external connection terminal, first power supply terminal, and second power supply terminal;
a bipolar transistor at an output stage whose emitter terminal is connected to the said external connection terminal and which is connected in an emitter-follower configuration;
first ESD protection means connected between the said first power supply terminal and the said external connection terminal;
second ESD protection means connected between the said second power supply terminal and the said external connection terminal;
inter-power supply ESD protection means connected between the said first power supply terminal and the said second power supply terminal;
current limiting means connected between a collector terminal of the said bipolar transistor and the said first power supply terminal; and
another bipolar transistor disposed between the said bipolar transistor and the said external connection terminal, in which a base terminal is connected to the emitter terminal of the said bipolar transistor and a collector terminal is connected to the said external connection terminal.

15. The semiconductor circuit according to claim 14, wherein the said current limiting means is a resistance element.

16. The semiconductor circuit according to claim 14, wherein an impedance Z [Ω] of the said current limiting means satisfies a relation:
(Vₒₙ/IEₘₐₓ)<Z<[{(VDD−VE)−VCEₘᵢₙ}/IC]
where Vₒₙ [V] represents an ON voltage of the said inter-power supply ESD protection means, IEₘₐₓ [A] represents a maximum emitter current value that can be handled by the said bipolar transistor, VCEₘᵢₙ [V] represents a minimum collector-to-emitter voltage when the said bipolar transistor is in operation, VE [V] represents the emitter voltage obtained when the said bipolar transistor is in operation, IC [A] represents the collector current when the said bipolar transistor is in operation, and VDD [V] represents the voltage of the said first power supply terminal.

17. The semiconductor circuit according to claim 14, wherein
the said first ESD protection means comprises a diode connected, in a forward direction, between the said first power supply terminal and the said external connection terminal,
the said second ESD protection means comprises a diode connected, in a forward direction, between the said external connection terminal and the said second power supply terminal, and
the said inter-power supply ESD protection means comprises a resistor, capacitor, and MOS transistor and causes the MOS transistor to perform snapback operation to feed current.

18. The semiconductor circuit according to claim 17, wherein the said first power supply terminal is a positive power supply terminal, and the said second power supply terminal is a negative power supply terminal.

19. The semiconductor circuit according to claim 14, wherein the said bipolar transistor is a circuit to be protected.

20. A high-frequency IC comprising a semiconductor circuit according to claim 14.
